(19) United States
(12) Patent Application Publication
(10) Pub. No.: US 2006/0212637 A1
(43) Pub. Date: Sep. 21, 2006

(54) Dock insertable into computer and receiving media player

(75) Inventors: Benjamin Lo, San Diego, CA (US); Milton Massey Frazier, San Marcos, CA (US); Mark Allen Hanson, San Jose, CA (US); Paul Hwang, Burbank, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 11/361,474

(22) Filed: Feb. 24, 2006

Related U.S. Application Data
(60) Provisional application No. 60/662,154, filed on Mar. 15, 2005.

(51) Int. Cl. G06F 13/00

(52) U.S. Cl. 710/303

(57) ABSTRACT

A dock can be slid into a receptacle of a computer. The dock has a media player bay for receiving a media player. The multimedia streams can be sent from the media player through the dock to the computer to be played on the computer speakers when the media player is operably engaged with the bay of the dock and the dock is operably engaged with the receptacle of the computer. The battery of the media player and/or dock can be charged from the computer.

This application claims priority from U.S. provisional patent application Ser. No. 60/662,154, filed Mar. 15, 2005.

### I. FIELD OF THE INVENTION

The present invention relates generally to media players.

### II. BACKGROUND OF THE INVENTION

Multimedia streams are provided on small portable media players. For instance, audio streams are provided on music players that can store a large number of streams, e.g., songs. As recognized herein, it would be advantageous to connect a music player with a user's computer, so that the audio streams on the music player can be played on relatively larger computer speakers when the user has both close at hand, and so that the audio streams can be backed up on the computer storage.

As also recognized herein, such connectivity might be provided with a universal serial bus (USB) cable extending between the media player and computer. However, the present invention understands the desirability of more closely coupling with the media player with the computer into a single integral package, for convenience. Also, the present invention recognizes that closer coupling could enable the computer to recharge the battery of the media player.

### SUMMARY OF THE INVENTION

An assembly is disclosed that is engageable with a computer. The assembly includes a dock configured for sliding into a receptacle of the computer, with the dock being formed with a bay. A media player is slidably engageable with the bay. The media player is configured to store and output multimedia streams. The multimedia streams can be sent from the media player through the dock to the computer to be played on a computer speaker when the media player is operably engaged with the bay of the dock and the dock is operably engaged with the receptacle of the computer.

In some implementations, when the dock is not engaged with the receptacle of the computer, the dock communicates with the computer through a wireless link or through a wired link such as a universal serial bus (USB) link. The computer may be a portable computer such as a notebook computer.

In non-limiting implementations the dock includes a connector and the computer includes a connector inside the receptacle, and the connectors engage each other when the dock is in the receptacle. If desired, the computer can charge a battery of the dock when the dock is engaged with the receptacle. Also, the media player can contain a battery that can be charged by the computer when the media player is engaged with the bay of the dock and the dock is engaged with the receptacle of the computer.

The dock may be provided with a speaker. In this implementation, when the dock is not disposed in the receptacle, the media player can be electrically connected to the speaker in the dock when the media player is engaged with the bay for playing the multimedia streams of the media player on the speaker of the dock.

In another aspect, a dock has an external contour configured for reception in a receptacle of a computer and a connector electrically contacting a connector of the computer when the dock is operably disposed within the receptacle. The dock is formed with an internal bay configured for reception of a media player therein. The internal bay has an internal media player connector electrically engaging a connector on the media player when the media player is operably disposed within the bay. Accordingly, when the dock is operably disposed within the receptacle and the media player is operably disposed within the bay, a battery of the media player can be charged by the computer and multimedia streams from the media player can be played on a speaker of the computer.

In yet another aspect, a method is disclosed for playing an multimedia stream. The method includes advancing a media player into a bay of a dock, with the media player being configured for storing multimedia streams. The method also includes advancing the dock into a receptacle of a computer and executing logic to automatically recognize the presence of the media player to facilitate playing an multimedia stream from the media player on the speaker of the computer.

In another aspect, a system has a video device including a video device display and a portable computer permanently coupled to the video device and including a built-in computer display. The video device can present a different display on the video device display than what is presented on the built-in computer display.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram showing the computer, dock, and media player in an exploded relationship;

FIG. 2 is a schematic diagram showing the media player disposed in the bay of the dock, in an exploded relationship with the computer, to illustrate that in a non-limiting embodiment the dock may communicate wirelessly with the computer, with the receptacle of the computer not shown for ease of exposition;

FIG. 3 is a schematic diagram showing the dock disposed in the receptacle of the computer, in an exploded relationship with the media player, to illustrate that in a non-limiting embodiment the media player may communicate wirelessly with the dock and/or computer, with the bay of the dock not shown for ease of exposition;

FIG. 4 is a block diagram showing various internal components of the computer, dock, and media player;

FIG. 5 is a schematic elevational view of the dock in two configurations, showing the dock can be propped up external to the computer; and

FIG. 6 is a schematic view of an alternate embodiment.

### DETAILED DESCRIPTION OF THE PREFERRED EMBODIMENT

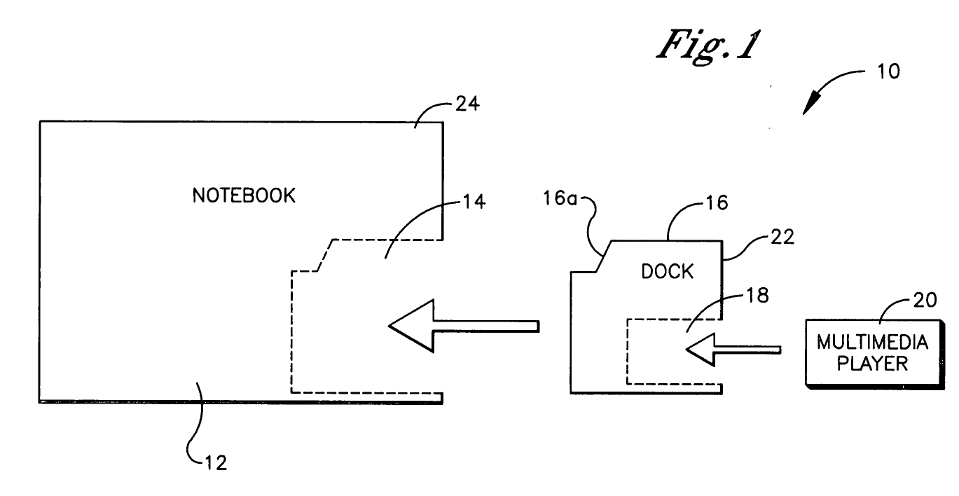

Referring initially to FIG. 1, a system is shown, generally designated 10, that includes a computer 12 such as but not limited to a notebook computer. The computer 12 may be formed with one or more receptacles 14 configured to accept a peripheral component. According to the present invention, a dock 16 is provided that can be advanced into the receptacle 14, and accordingly the dock 16 has a contour that, as shown, generally matches the contour of the receptacle 14, including, e.g., having a beveled surface 16a. That is, the dock 16 may have an external contour that is appropriate for engaging a general purpose computer receptacle that can otherwise be used to engage other peripheral components such as disk drives.

As set forth further below, the dock 16 is formed with at least one bay 18, and a media player 20 can be advanced into the bay. By “media player” is meant a device that can both store and play back multimedia files including audio-only files and/or video files without the need for other components, as opposed to a disk or other storage-only device that can only store files but that has no play back capability absent an external drive or player. Accordingly, the media player may include a visual display for viewing video, as well as include audio speakers.

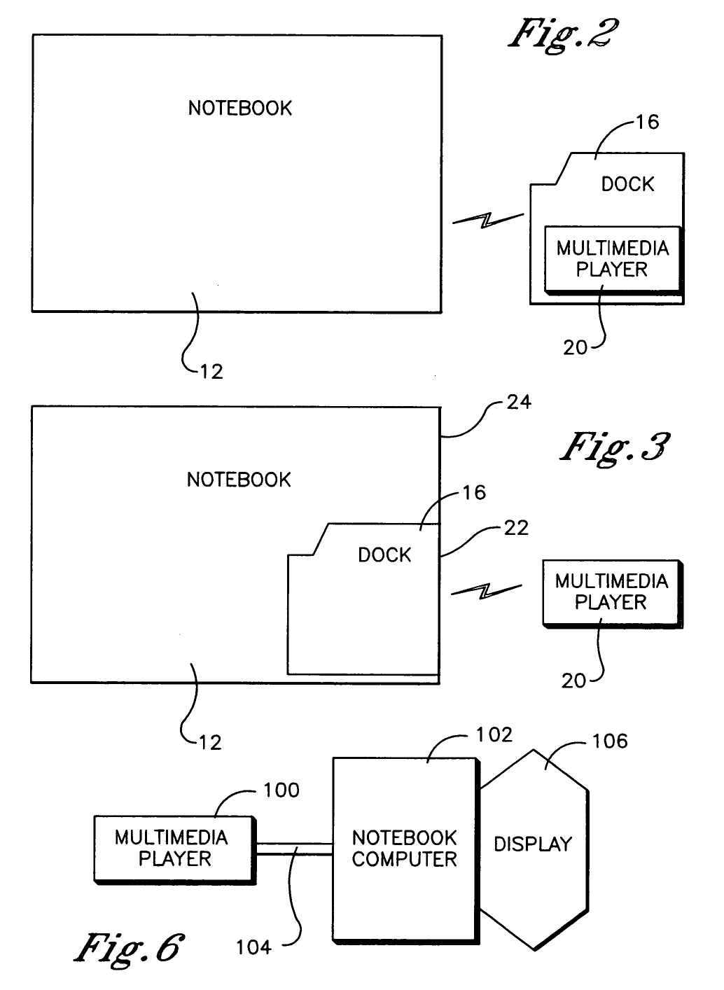

FIG. 2 shows the media player 20 advanced into the bay 18 of the dock 16, and FIG. 3 shows the dock 16 advanced into the receptacle 14 of the computer 12. As shown in FIG. 3, when the dock 16 is engaged with the receptacle 14 of the computer 12, a rear surface 22 of the dock 16 is flush with a front face 24 of the computer 12. In alternate implementations the dock may be integral with the computer so that it is not intended to be removed by a user.

The media player 20 may be any suitable media player that can store multimedia streams such as music tracks. In non-limiting implementations the media player 20 stores music files that the user can listen to by, e.g., using headphones or by streaming from the media player 20 to the computer 12 as more fully set forth below. In non-limiting implementations, supported music formats include MP3, WMA, and ATRAC3. The media player 20 may, without limitation, use Microsoft Windows Media Player 10 DRM (Janus) for WMA files and OpenMG for ATRAC3 files for copy protection. The media player 20 can be automatically recognized by the computer when docked in the dock 16 to cause the appropriate music application to be launched in the computer 12.

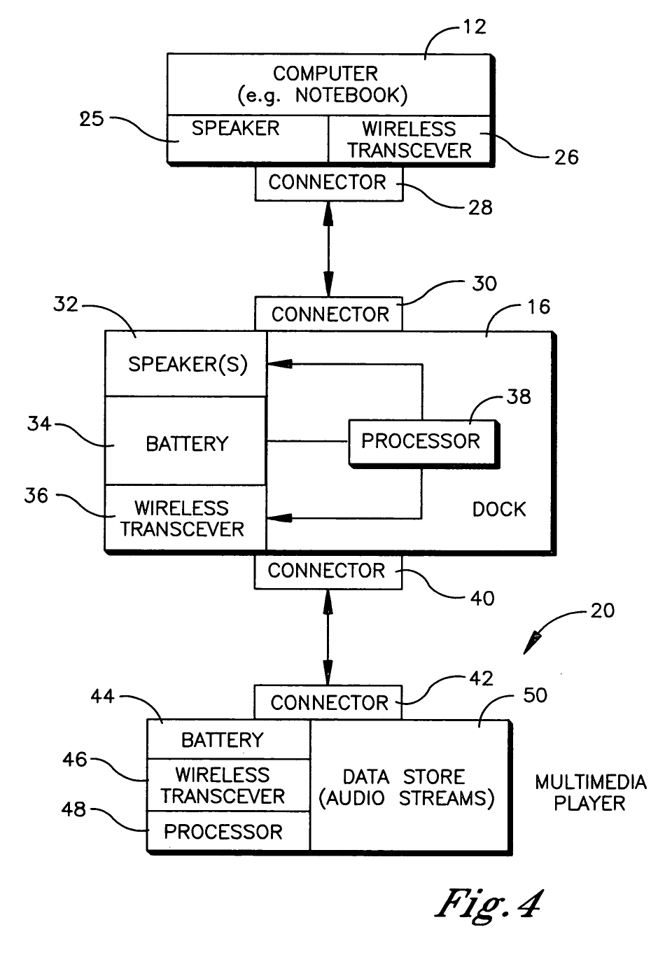

FIG. 4 shows details of the components discussed above. The computer 12 may have one or more audio speakers 25 and a wireless transceiver 26 such as but not limited to a Bluetooth transceiver. The computer 12 may also have a connector 28 that may be, without limitation, configured in accordance with universal serial bus (USB) principles. It is to be understood that the connector 28 of the computer 12 may be disposed rearwardly in the receptacle 14 shown in FIG. 1, so that when the dock 16 is disposed in the receptacle 14, a dock connector 30 that is configured complementarily with the computer connector 28 can engage the computer connector 28 to establish electrical connectivity between the dock 16 and computer 12.

FIG. 4 shows that the non-limiting dock 16 may have one or more audio speakers 32, although in some implementations the dock 16 has no speakers. The dock 16 may also have an internal dock battery 34 and a wireless transceiver 36, for purposes to be shortly disclosed. In one implementation the dock 16 includes a dock processor 38 that is electrically connected to other dock components.

In addition to the dock connector 30 that engages the computer connector 28, the dock 16 may also include, within the bay 18 shown in FIG. 1, a player connector 40 that is configured to engage a complementarily-shaped media player connector 42 on the media player 20 when the media player 20 is sittin' in the bay of the dock. The media player 20 may also include an internal battery 44, a wireless transceiver 46, and a processor 48 that can access a data store 50 such as a thin form hard disk drive or solid state memory to play multimedia streams stored in the data store 50.

With the explanation of FIG. 4 in mind and returning to FIGS. 1-3, various operating logic now may be appreciated, it being understood that the operating logic may be undertaken by one or more of the computer 12 and the processors 38, 48. When the media player 20 is in the bay 18 of the dock 16 and the dock 16 is in the receptacle 14 of the computer 12, one or both of the dock battery 34 and media player battery 44 may be charged from the computer 12.

Also, the media player 20 can be turned on or off by an appropriately configured hardware switch to send multimedia streams through the dock 16 to the computer 12 via the connectors 42, 40, 30 for playing the streams on the speaker 25 of the computer 12. In this way, the media player 20 is closely coupled to the computer 12 and no USB cords need extend between the media player 20 and computer 12 to play multimedia streams in the media player 20. Further, audio on the computer can be automatically synchronized with the streams on the media player 20 when the player 20 is docked in the bay 18.

This synchronization may include automatically transferring player 20 streams to the computer 12 and synchronizing the streams with streams already stored in the computer 12 so that only streams that are not already stored in the computer 12 need be transferred from the media player 20. Likewise, streams in the computer 12 that are not in the media player 20 may be transferred to the media player 20. To this end, the computer 12 can ensure that the player 20 is allowed to accept and copy audio files from the computer 12 to ensure compliance with applicable digital rights management (DRM) rules. If the DRM rules are satisfied, audio files that are not already stored on the media player 20 may be transferred thereto automatically without user interaction beyond engaging the dock with the computer and the media player with the dock. The automatic synchronization feature may be invoked by default and may be disabled by the user if desired. Removing the media player 20 from the dock 16 can be achieved by using an ejection mechanism similar to a PC card ejection mechanism.

When the dock 16 is provided with speakers 32, the media player 20 is in the bay 18, and the dock 16 is not engaged with the computer 12 (FIG. 2), multimedia streams from the media player 20 can be played on the dock speakers 32. In one non-limiting implementation the dock speakers 32 may be passive/active speakers that are powered by the dock battery 34 by, e.g., manipulating a hardware switch on the dock 16 to the on position. If desired, the dock battery 34 can be removed from the dock 16 and used in lieu of or in addition to the media player battery 44 to power the media player 20.

In any case, the dock 16 may communicate wirelessly with the computer 12 using their respective transceivers 36, 26, so that in lieu of providing speakers on the dock 16 audio files from the media player 20 may be wirelessly communicated to the computer 12 for playing on the computer speakers 25 even when the dock 16 is not engaged with the computer receptacle 14. Yet again, as shown in FIG. 3 when the media player 20 is not engaged with the dock 16 it may nonetheless communicate wirelessly with one or both of the dock 16 and computer 12 using the media player wireless transceiver 46, to play multimedia streams from the media player 20 on the computer speakers 25. In other embodiments the various links between the computer 12, dock 16, and media player 20 when the components are not physically engaged with each other may be a wired link achieved by means of, e.g., USB cables.

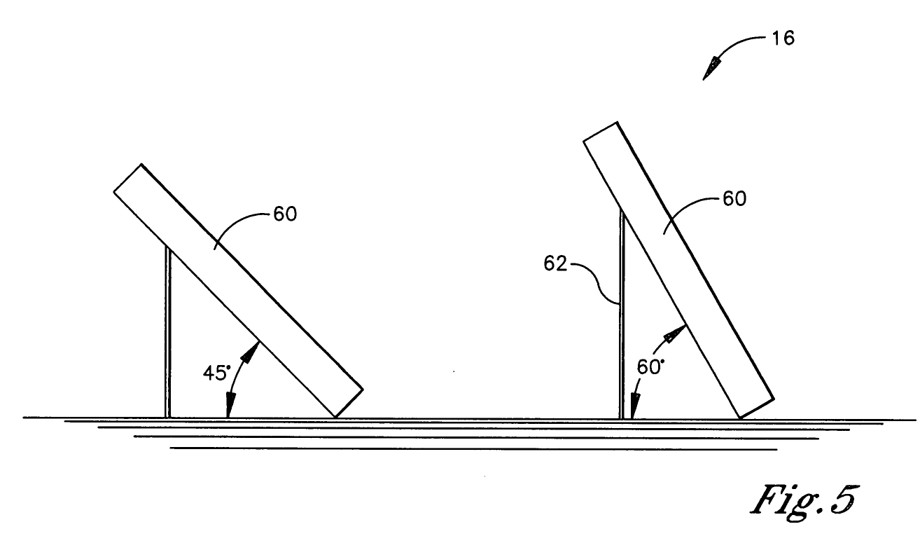

As shown in FIG. 5, the dock 16 may include a body 60 containing the dock components shown in FIG. 4. One or more legs or stands 62 can be pivotably attached to the body 60 to prop the dock 16 up at various angles, e.g., at 45° or 60°.

FIG. 6 shows that in an alternate embodiment, a video device 100 can be permanently coupled to a computer such as a notebook computer 102 using a mechanical rigid coupling 104 such as a hinge or arm or other coupling that preferably permits the video device 100 to be folded against and away from the computer 102. The computer 102 also has a conventional built-in display 106 that may be folded against and away from the keyboard of the computer in accordance with principles known in the art. The video device 100 can present a different display than what is presented on the built-in display 106. In one implementation the video device 100 is substantially identical to the media players disclosed above and hence includes its own processor, storage, and perhaps power supply apart from the processor and like components of the computer 102, and thus may display data from its own internal storage. In other implementations the video device 100 may or may not have its own processor and storage but regardless, can display data stored within the computer 102. In other embodiments, the video device 100 is a display-only device that can be slidably engaged with a dock or directly with a computer, in lieu of being permanently coupled to the computer. In some embodiments the video device 100 is not rigidly coupled to the computer, and may communicate with the computer by wired (electrical cord) or wireless connections.

While the particular DOCK INSERTABLE INTO COMPUTER AND RECEIVING Media player as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. An assembly engageable with a computer, comprising:
a dock configured for sliding into a receptacle of the computer, the dock being formed with at least one bay; and
at least one media player slidably engageable with the bay, the media player configured to store and output multimedia streams, wherein the computer includes at least one computer speaker, and the multimedia streams can be sent from the media player through the dock to the computer to be played on the computer speaker when the media player is operably engaged with the bay of the dock and the dock is operably engaged with the receptacle of the computer.

2. The assembly of claim 1, wherein when the dock is not engaged with the receptacle of the computer, the dock communicates with the computer through a link.

3. The assembly of claim 2, wherein the link is wireless.

4. The assembly of claim 2, wherein the link is wired.

5. The assembly of claim 4, wherein the link is a universal serial bus (USB) link.

6. The assembly of claim 1, comprising the computer.

7. The assembly of claim 6, wherein the computer is a portable computer.

8. The assembly of claim 6, wherein the dock includes a connector and the computer includes a connector inside the receptacle, the connectors engaging when the dock is in the receptacle.

9. The assembly of claim 6, wherein the computer can charge a battery of the dock when the dock is engaged with the receptacle.

10. The assembly of claim 9, wherein the media player contains a battery chargeable by the computer when the media player is engaged with the bay of the dock and the dock is engaged with the receptacle of the computer.

11. The assembly of claim 10, wherein the dock includes at least one speaker, and the media player is electrically connected to the speaker in the dock when the media player is engaged with the bay for playing the multimedia streams of the media player on the speaker of the dock when the dock is not disposed in the receptacle.

12. The assembly of claim 6, wherein the receptacle of the computer extends into the computer from a face, the dock defines a surface, and the surface of the dock is flush with the face of the computer when the dock is engaged with the receptacle of the computer.

13. A dock, comprising:
an external contour configured for reception in a receptacle of a computer;
a connector electrically contacting a connector of the computer when the dock is operably disposed within the receptacle; and
an internal bay configured for reception of a media player therein, the internal bay having an internal media player connector electrically engaging a connector on the media player when the media player is operably disposed within the bay, wherein when the dock is operably disposed within the receptacle and the media player is operably disposed within the bay, a battery of the media player can be charged by the computer and multimedia streams from the media player can be played on a speaker of the computer.

14. The dock of claim 13, comprising the media player.

15. The dock of claim 13, comprising the computer.

16. The dock of claim 15, comprising the media player.

17. The dock of claim 13, wherein the receptacle of the computer extends into the computer from a face, the dock defines a surface, and the surface of the dock is flush with the face of the computer when the dock is engaged with the receptacle of the computer.

18. The dock of claim 13, wherein when the dock is not engaged with the receptacle of the computer, the dock communicates with a processor of the computer through a link.

19. The dock of claim 13, wherein the computer can charge a battery of the dock when the dock is engaged with the receptacle.

20. The dock of claim 13, wherein the dock includes at least one speaker, and the media player is electrically connected to the speaker in the dock when the media player is operably engaged with the bay for playing the multimedia streams of the media player on the speaker of the dock when the dock is not operably disposed in the receptacle.

21. A method for playing an multimedia stream, comprising:
advancing a media player into a bay of a dock, the media player configured for storing multimedia streams;
advancing the dock into a receptacle of a computer having at least one speaker; and
executing logic to automatically recognize the presence of the media player to facilitate playing an multimedia stream from the media player on the speaker of the computer.

22. The method of claim 21, comprising advancing the dock into the receptacle until a surface of the dock is flush with a face of the computer.

23. The method of claim 21, comprising automatically synchronizing the media player with the computer.

24. The method of claim 21, comprising copying an multimedia stream from the computer onto the media player only if the computer determines that the media player is authorized to receive the stream.

25. The method of claim 21, comprising charging a battery of the media player from the computer.

26. The method of claim 21, comprising playing an multimedia stream from the media player on a speaker of the dock when the dock is not operably engaged with the computer.

27. A system, comprising:
a video device including a video display; and
a portable computer coupled to the video device, the computer including a built-in computer display, wherein
the video device can present a different display on the video device display than what is presented on the built-in computer display.

28. The system of claim 27, wherein the video device includes its own processor and storage apart from a processor of the computer, and thus may display data from its own internal storage.

29. The system of claim 27, wherein the video device displays data stored within the computer.

30. The system of claim 27, wherein the video device is affixed to the computer by a mechanical rigid coupling.

31. The system of claim 27, wherein the video device wirelessly communicates with the computer.

32. The system of claim 27, wherein the video device communicates with the computer over an electrical cord.
